(19) United States
(12) Patent Application Publication
(10) Pub. No.: US 2017/0051129 A1
(43) Pub. Date: Feb. 23, 2017

(54) OXYGEN-ABSORBING RESIN COMPOSITION AND OXYGEN-ABSORBING FILM

(71) Applicant: Kyodo Printing Co., Ltd., Tokyo (JP)

(72) Inventors: Natsuki SAKAMOTO, Tokyo (JP); Yumiko HAGIO, Tokyo (JP); Tatsuya OGAWA, Tokyo (JP); Atsushi TAKAHASHI, Tokyo (JP); Yoshiyuki NAKAZATO, Tokyo (JP); Hiroyuki SANO, Tokyo (JP)

(73) Assignee: Kyodo Printing Co., Ltd., Tokyo (JP)

(21) Appl. No.: 15/118,645

(22) PCT Filed: Feb. 12, 2015
(86) PCT No.: PCT/JP2015/053837

§ 371 Date: Aug. 12, 2016

(30) Foreign Application Priority Data
Feb. 12, 2014 (JP) 2014-024831
Aug. 12, 2014 (JP) 2014-164412

(51) Int. Cl. C08K 5/13; C08J 3/28; B65D 81/26; C08K 3/26; B65D 65/40; C08J 5/18; C08K 5/098

(52) U.S. Cl. CPC C08K 5/13; C08J 5/18; C08J 3/28; C08K 5/098; C08K 3/26; B65D 65/40; B65D 81/266

(57) ABSTRACT

Provided is an oxygen-absorbing resin composition having high oxygen absorption properties and having high film production suitability. The oxygen-absorbing resin composition includes a benzenetriol, an alkali metal or an alkali earth metal salt, and a binder resin. The iron content is no more than 1% by mass of the total mass.

### TECHNICAL FIELD

The present invention relates to an oxygen-absorbing resin composition and an oxygen-absorbing film containing the same. More particularly, the present invention relates to an oxygen-absorbing resin composition for producing an oxygen-absorbing film that is preferable as a packaging material for foods, chemical agents, pharmaceuticals, cosmetics or electronic components and the like and is easily produced.

### BACKGROUND ART

Oxygen absorbers are enclosed in packages used for products such as foods, chemical agents, pharmaceuticals, cosmetics or electronic components. Iron powder-based oxygen absorbers using iron powder as the main reactant are typically used as oxygen absorbers from the viewpoints of cost and oxygen absorption performance.

Patent Document 1, for example, discloses an iron powder-based oxygen-absorbing resin composition comprising iron powder, an alkaline metal halide or alkaline earth metal halide and a polyvalent phenol compound. Here, an example of the alkaline metal halide or alkaline earth metal halide is listed as calcium chloride, and this is used as an oxidation accelerator of the iron powder. Examples of the polyvalent phenol are listed as catechol, pyrogallol and gallic acid, and this is used to inhibit the generation of hydrogen attributable to the iron powder.

Although this type of iron powder-based oxygen absorber has a high level of oxygen absorption performance, it also has the shortcomings of reacting to metal detectors used for contaminant inspections and igniting when used in a microwave oven.

Therefore, organic oxygen absorbers have been developed that use an organic substance for the main reactant. Patent Document 2, for example, discloses an organic oxygen absorber comprising a low molecular weight phenol compound and a crystallization water-containing alkaline compound. This oxygen absorber is used as a powder that is filled into an air-permeable package. It specifically discloses catechol as the low molecular weight phenol compound, and sodium carbonate decahydrate, ammonium borate octahydrate and ammonium oxalate monohydrate being specifically disclosed as examples of the crystallization water-containing alkaline compound.

Patent Document 3 discloses an organic oxygen absorber comprising gallic acid and a transition metal compound, and an oxygen-absorbing resin composition comprising the organic oxygen absorber and a binder resin, and an optional carbonic acid-based alkaline compound. Here, a resin composition, in which an oxygen absorber comprising gallic acid, a carbonic acid-based alkaline compound and a transition metal compound is contained in the binder resin at less than 10.3% by weight based on total weight, namely an oxygen-absorbing resin composition containing a binder resin at greater than 89.7% by weight, is formed into a film.

### PRIOR ART DOCUMENTS

### Patent Documents

Patent Document 1: Japanese Unexamined Patent Publication No. 2001-9273

Patent Document 2: Japanese Unexamined Patent Publication No. H9-70531

Patent Document 3: Japanese Unexamined Patent Publication No. 2011-92921

### DISCLOSURE OF THE INVENTION

### Problems to be Solved by the Invention

However, according to studies conducted by the inventors of the present invention, it was determined to be difficult to form a film when the amount of the main reactant, in the form of gallic acid in particular, is increased in the oxygen-absorbing resin composition described in Patent Document 3. In other words, since bubbles are formed during the film formation, which result in the formation of holes in the film, it was determined that inflation molding cannot be used to form the film, and it was also determined that the film ends up tearing thereby preventing the film from being formed even if obtained by T-die extrusion. In addition, even if the film is able to be obtained by T-die extrusion, the high surface roughness makes it difficult to laminate with other films, while also resulting in the problem of low film strength.

Therefore, an object of the present invention is to provide an oxygen-absorbing resin composition that has high oxygen absorption performance and high film production suitability.

### Means for Solving the Problems

As a result of conducting extensive studies, the inventors of the present invention found that the aforementioned problems can be solved by the following means. Namely, the present invention is as indicated below.

<Aspect 1>

An oxygen-absorbing resin composition, comprising: a benzenetriol, a salt of an alkaline metal or alkaline earth metal and a binder resin; wherein, iron content is 1% by weight or less based on total weight.

<Aspect 2>

The composition described in Aspect 1, wherein the content of resin binder is 89.7% or less based on total weight.

<Aspect 3>

The composition described in Aspect 1 or 2, further comprising a transition metal compound.

<Aspect 4>

The composition described in Aspect 3, comprising 0.0001 parts by weight to 0.8 parts by weight of the transition metal compound based on 1 part by weight of the benzenetriol.

<Aspect 5>

The composition described in any of Aspects 1 to 4, comprising 0.005 parts by weight to 5.0 parts by weight of the salt of an alkaline metal or alkaline earth metal based on 1 part by weight of the benzenetriol.

<Aspect 6>

The composition described in any of Aspects 1 to 5, wherein the benzenetriol is pyrogallol, hydroxyquinol or a mixture thereof, and melt mass-flow rate in the case of measuring in compliance with JIS K7210 under conditions of a temperature of 190° C. and load of 21.18 N is 0.5 g/10 min to 18.0 g/10 min.

<Aspect 7>

The composition described in Aspect 6, wherein the content of the pyrogallol, hydroxyquinol or mixture thereof is 2.0% by weight to 31.0% by weight based on total weight.

<Aspect 8>

The composition described in any of Aspects 1 to 7, wherein melt mass-flow rate in the case of measuring in compliance with JIS K7210 under conditions of a temperature of the binder resin of 190° C. and load of 21.18 N is 0.1 g/10 min to 18.0 g/10 min.

<Aspect 9>

The composition described in Aspect 8, wherein the melt mass-flow rate is less than 7.3 g/10 min.

<Aspect 10>

The composition described in any of Aspects 1 to 9, which is subjected to radiation treatment or heat treatment.

<Aspect 11>

An oxygen-absorbing film obtained by forming the composition described in any of Aspects 1 to 10.

<Aspect 12>

The film described in Aspect 11, having a thickness of 20 μm to 100 μm.

<Aspect 13>

The film described in Aspect 11 or 12, wherein arithmetic average roughness Ra measured in compliance with ISO4287 is 3.0 μm or less.

<Aspect 14>

The film described in any of Aspects 11 to 13, which is subjected to radiation treatment or heat treatment.

<Aspect 15>

A packaging body fabricated using the film described in any of Aspects 11 to 14.

<Aspect 16>

A method for producing an oxygen-absorbing film, comprising:

kneading a main reactant in the form of pyrogallol, hydroxyquinol or a mixture thereof and a salt of an alkaline metal or alkaline earth metal into a binder resin to obtain a resin composition having a melt mass-flow rate of 0.5 g/10 min to 18.0 g/10 min in the case of measuring in compliance with JIS K7210 under conditions of a temperature of the binder resin of 190° C. and load of 21.18 N, and

a forming the resin composition into a film at a temperature of 130° C. to 250° C.

<Aspect 17>

The method described in Aspect 16, further comprising carrying out a radiation treatment or heat treatment on the film.

### Effects of the Invention

The oxygen-absorbing resin composition of the present invention has a high level of oxygen absorption performance and does not react with metal detectors or microwave ovens. In addition, since this composition has a high degree of film production suitability even though it contains a large amount of a main reactant, the use of this composition makes it possible to form a high-performance oxygen-absorbing film. For example, since the use of this composition substantially eliminates the occurrence of bubbling, the film can be formed by inflation molding. In addition, since a film obtained from this composition has low surface roughness, it can be used by laminating with other films, thereby enabling it to be used in various applications.

### BRIEF DESCRIPTION OF THE DRAWINGS

FIG. 1 is a graph showing the relationship between the content of main reactant (x) and melt mass-flow rate (MFR, y) of an oxygen-absorbing resin composition in the case of using an oxygen absorber comprising 100 parts by weight of pyrogallol, 50 parts by weight of potassium carbonate and 5 parts by weight of iron (III) stearate.

### EMBODIMENTS FOR CARRYING OUT THE INVENTION

The oxygen-absorbing resin composition of the present invention comprises a benzenetriol, a salt of an alkaline metal or alkaline earth metal, and a binder resin. Here, the meaning of “comprises” includes the meaning of “obtained by containing”. In the case of referring to each component in the present description as percent by weight or weight ratio, these refer to both an amount contained in that composition and an amount contained in order to obtain that composition. Furthermore, in the present description, a mixture comprising a main reactant, a salt of an alkaline metal or alkaline earth metal, and optionally a transition metal compound, may refer to an oxygen absorber.

In addition, in the oxygen-absorbing resin composition of the present invention, iron content is preferably 1% by weight or less or 0.5% by weight or less based on total weight, and more preferably, this resin composition, even if containing iron, does not contain a substantial amount of iron to a degree that the resin composition significantly reacts with metal detectors or microwave ovens. Here, iron refers to iron metal in particular, and an example of the form thereof is iron powder.

In the case of using the oxygen-absorbing resin composition of the present invention for the purpose of absorbing oxygen, the composition of the present invention can be used by enclosing in a pouch composed of a laminate having, for example, PET/aluminum foil/polypropylene in that order. In this case, the composition of the present invention can be used by sealing in an oxygen-permeable container or package prior to enclosing in the pouch. In addition, as will be subsequently described, by forming the oxygen-absorbing resin composition of the present invention into an oxygen-absorbing film, it can be laminated with other films and the like to obtain a packaging material having oxygen absorbability (oxygen-absorbing material). In the case of using the oxygen-absorbing resin composition of the present invention or molded article thereof for the purpose of absorbing oxygen, it is extremely useful for preventing oxidative degradation of foods, chemical agents, pharmaceuticals, cosmetics or electronic components and the like since it does not significantly react with metal detectors or microwave ovens.

(Benzenetriol)

The oxygen-absorbing resin composition of the present invention is able to impart a high-performance oxygen-absorbing film by using a benzenetriol for the main reactant thereof. Examples of benzenetriols include pyrogallol, hydroxyquinol, phloroglucinol and mixtures thereof.

The inventors of the present invention unexpectedly discovered that bubbling during film formation can be inhibited by using a benzenetriol for the main reactant. The benzenetriol is preferably in the form of an anhydride in order to inhibit bubbling more effectively. Inhibition of bubbling makes it possible to obtain a film despite the oxygen-absorbing resin composition containing a large amount of main reactant, thereby allowing the obtaining of an oxygen-absorbing film having a high level of oxygen absorption performance. In addition, being able to inhibit bubbling makes it possible to form the film by inflation molding. Moreover, a film obtained in this manner has low surface roughness, thereby enabling it to be laminated with other films and enabling it to be used in various applications.

An oxygen-absorbing substance other than benzenetriol may be used in combination therewith as a main reactant to a degree that does not cause bubbling of the film. Examples of oxygen-absorbing substances used in combination with benzenetriol include polyvalent phenol compounds and ascorbic acid. The examples of polyvalent phenol compounds include phenol, catechol, gallic acid, resorcinol, hydroquinone, cresol and tannic acid. In addition, iron may also be contained in the composition of the present invention as an oxygen-absorbing substance provided the content thereof is 1% by weight or less based on the total weight of the composition.

(Salt of Alkaline Metal or Alkaline Earth Metal)

The salt of an alkaline metal or alkaline earth metal has the effect of making the system containing the resin composition of the present invention basic, thereby enhancing the oxygen absorption performance of the oxygen-absorbing resin composition of the present invention. Without being bounded be theory, since the absorption of oxygen by a benzenetriol is thought to occur due to the generation of water as a result of hydrogen reacting with oxygen, if the system becomes basic, hydrogen of the hydroxyl groups of the benzenetriol dissociates easily making it easier to react with oxygen.

The containing of a salt of an alkaline metal or alkaline earth metal in the resin composition of the present invention makes it possible to support the benzenetriol that melted during film formation thereon. Namely, since the temperature at which a film is normally formed is higher than the melting points of benzenetriols, and particularly the melting points of pyrogallol and hydroxyquinol (about 130° C.), in the case of forming the resin composition of the present invention into a film, the benzenetriol is melted therein. On the other hand, since the melting point of a salt of an alkaline metal or alkaline earth metal is higher than the temperature of film formation, it can be maintained in solid form. The presence of a salt of an alkaline metal or alkaline earth metal causes benzenetriol that has become liquefied during film formation to adhere thereto, thereby facilitating its retention in the resin composition.

The salt of an alkaline metal or alkaline earth metal is preferably a weakly acidic salt of an alkaline metal or alkaline earth metal, and examples of weakly acidic salts include carbonates, phosphates, pyrophosphates and acetates. More specifically, examples include lithium carbonate, beryllium carbonate, magnesium carbonate, potassium carbonate, calcium carbonate, lithium phosphate, beryllium phosphate, sodium phosphate, magnesium phosphate, potassium phosphate, calcium phosphate, lithium pyrophosphate, beryllium pyrophosphate, sodium pyrophosphate, magnesium pyrophosphate, potassium pyrophosphate, calcium pyrophosphate, lithium acetate, beryllium acetate, sodium acetate, magnesium acetate and calcium acetate. Potassium carbonate is preferable in consideration of safety and price. One type of these salts may be used alone or a plurality of types may be used in combination.

The oxygen-absorbing resin composition of the present invention preferably contains 0.005 parts by weight or more, 0.01 part by weight or more, 0.05 parts by weight or more or 0.1 part by weight or more, and 5.0 parts by weight or less, 3.0 parts by weight or less, 2.0 parts by weight or less, 1.5 parts by weight or less or 1.0 part by weight or less based on 1 part by weight of the benzenetriol. In the case of containing 0.01 parts by weight or more in particular, the main reactant is effectively retained in the composition and does not educt on the surface even when forming a film, thereby making this preferable.

(Transition Metal Compound)

The oxygen-absorbing resin composition of the present invention preferably further contains a transition metal compound. A transition metal compound has the function of a catalyst when the benzenetriol reacts with oxygen, and the transition metal compound is thought to be able to impart high oxygen absorbability to the resin composition of the present invention.

The transition metal compound used in the present invention is preferably a salt of a transition metal ion and an inorganic acid or organic acid or a complex compound of a transition metal ion and an organic compound, and a hydrate or anhydride thereof can be used. However, in the case of a hydrate, since water vapor generated during film formation may cause bubbling, an anhydride of a transition metal compound is used preferably. The transition metal compound may be used alone or a plurality of transition metal compounds may be used as a mixture.

Examples of transition metals include Fe, Cu, Mn, V, Cr, Co, Ni and Zn, and among these, Fe, Cu or Mn is preferable. Specific examples of transition metal compounds include manganese (II) stearate, iron (III) stearate, cobalt (II) stearate, nickel (II) stearate, copper (II) stearate, zinc (II) stearate, tris(2,4-pentanedionato)manganese (III), tris(2,4-pentanedionato)iron (III), tris(2,4-pentanedionato)cobalt (III), bis(2,4-pentanedionato)copper (II), bis(2,4-pentanedionato)zinc (II), iron (III) chloride, nickel (II) chloride, copper (II) chloride, zinc (II) chloride and copper (II) sulfate. Iron salt compounds are preferable from the viewpoint of safety.

The oxygen-absorbing resin composition of the present invention preferably contains 0.0001 part by weight or more, 0.001 part by weight or more, 0.01 part by weight or more, 0.05 parts by weight or more or 0.1 part by weight or more, and 3.0 parts by weight or less, 1.5 parts by weight or less, or 1.0 part by weight or less, or 0.8 part by weight or less of the transition metal compound based on 1 part by weight of the benzenetriol. If the amount of transition metal compound is within these ranges, it can be mixed comparatively uniformly, there is no occurrence of fluctuations in oxygen absorption capacity and oxygen absorption capacity can be adequately imparted. In addition, there is little susceptibility to the occurrence of problems such as overflow of resin from the vent port during kneading of the resin composition.

(Binder Resin)

There are no particular limitations on the binder resin used in the oxygen-absorbing resin composition of the present invention provided it is a thermoplastic resin that is able to be kneaded with the benzenetriol and salt of an alkaline metal or alkaline earth metal. Examples of such resins include polystyrene-based resin, polyester-based resin, acrylic-based resin, polyamide-based resin, polyvinyl alcohol-based resin, polyurethane-based resin, polyolefin-based resin, polycarbonate-based resin, polysulfone-based resin, derivatives thereof and mixtures thereof. Other substances are incorporated in the oxygen-absorbing resin composition of the present invention so that the content of the binder resin is 40% by volume or more, and preferably the binder resin content in the composition is 50% by volume or more and more preferably 60% by volume or more.

Specific examples of polyolefin-based resins include polyethylene-based resin and polypropylene-based resin. Examples of polyethylene-based resins include low density polyethylene (LDPE), linear low density polyethylene (LLDPE), medium density polyethylene (MDPE), high density polyethylene (HDPE), ethylene acrylic acid copolymer (EAA), ethylene-methacrylic acid copolymer (EMAA), ethylene-ethyl acrylate copolymer (EEA), ethylene-methyl acrylate copolymer (EMA), ethylene-vinyl acetate copolymer (EVA), carboxylic acid-modified polyethylene, carboxylic acid-modified ethylene-vinyl acetate copolymer, ionomers, derivatives thereof and mixtures thereof. In addition, examples of polypropylene-based resins include polypropylene (PP) homopolymer, random polypropylene (random PP), block polypropylene (block PP), chlorinated polypropylene, carboxylic acid-modified polypropylene, derivatives thereof and mixtures thereof.

An example of a thermal property of thermoplastic resins able to be used in the present invention is melt mass-flow rate, and melt mass-flow rate in the case of measuring in compliance with JIS K7210 is preferably 0.1 g/10 min or more, 0.5 g/10 min or more, 1.0 g/10 min or more, 3.0 g/10 min or more or 5.0 g/10 min or more, and 100 g/10 min or less, 50 g/10 min or less or 30 g/10 min or less.

However, in the case of using a high content of pyrogallol and/or hydroxyquinol for the main reactant, the melt mass-flow rate of the binder resin in the case of measuring in compliance with JIS K7210 under conditions of a temperature of 190° C. and load of 21.18 N is preferably 0.01 g/10 min or more, 0.05 g/10 min or more, 0.1 g/10 min or more, 0.2 g/10 min or more or 0.3 g/10 min or more, and 18.0 g/10 min or less, 15.0 g/10 min or less, 10.0 g/10 min or less, less than 7.3 g/10 min or 5.0 g/10 min or less. In this aspect of the present invention, even in the case of a hard resin typically not used in the prior art having an MFR of less than 7.3 g/10 min, such resin was determined to be useful as a binder resin in the case of using a comparatively large amount of pyrogallol and/or hydroxyquinol that melt during film formation.

The binder resin used in the oxygen-absorbing resin composition of the present invention preferably has high oxygen permeability. In the case of forming the binder resin used in the present invention into a film having a thickness of 25 μm, the oxygen permeability of that film as measured in compliance with JIS K7126-2 is preferably 20 cc/m²/hr/atm or more, 50 cc/m²/hr/atm or more or 100 cc/m²/hr/atm or more.

The binder resin is contained in the oxygen-absorbing resin composition of the present invention based on the total weight of the composition at preferably 50% by weight or more, 60% by weight or more, 70% by weight or more or 75% by weight or more, and 98% by weight or less, 95% by weight or less, 90% by weight or less, 89.7% by weight or less or 85% by weight or less. In addition, the oxygen absorber comprising benzenetriol, a salt of an alkaline metal or alkaline earth metal and optionally a transition metal compound, is preferably contained, based on total weight, at 2% by weight or more, 5% by weight or more, 10% by weight or more, 10.3% by weight or more or 15% by weight or more, and contained at 50% by weight or less, 40% by weight or less, 30% by weight or less or 25% by weight or less. If the amount of oxygen absorber is within these ranges, a high level of oxygen absorption performance can be demonstrated and film production suitability is favorable.

<Oxygen-Absorbing Film, Production Method Thereof and Packaging Body Using the Same>

The oxygen-absorbing film of the present invention preferably has a thickness of 300 μm or less, 100 μm or less or 80 μm and preferably has a thickness of 10 μm or more or 20 μm or more, and can be produced by forming the aforementioned oxygen-absorbing resin composition into the form of a film.

The arithmetic average roughness Ra of the surface of the oxygen-absorbing film of the present invention in the case of measuring in compliance with ISO4287 is preferably 3.00 μm or less, 2.00 μm or less, 1.00 μm or less, 0.80 μm or less or 0.50 μm or less.

Although there are no particular limitations thereon, examples of methods used to form the oxygen-absorbing film include single-layer or multilayer inflation molding, T-die extrusion and casting, with T-die extrusion and inflation molding being particularly preferable.

An oxygen-absorbing resin composition in pellet form (master batch) can be prepared by extruding a kneaded mixture of materials contained in the aforementioned oxygen-absorbing resin composition into pellets and cooling prior to forming the oxygen-absorbing film. Kneading can be carried out using, for example, a batch-type kneading machine such as a kneader, Banbury mixer, Henschel mixer or mixing roll, or a continuous kneading machine such as a twin screw kneading machine. At this time, the materials can be kneaded at a temperature of 120° C. or higher, 140° C. or higher or 150° C. or higher and 220° C. or lower, 200° C. or lower or 180° C. or lower corresponding to the materials used.

The oxygen-absorbing film of the present invention can be produced by, for example, kneading a main reactant, salt of an alkaline metal or alkaline earth metal and optionally, a transition metal compound with a binder resin using a twin screw kneading extruder and the like followed directly by forming the film, for example, by inflation molding or T-die extrusion at a temperature of 130° C. or higher, 135° C. or higher, 140° C. or higher or 150° C. or higher and 250° C. or lower, 220° C. or lower or lower than 200° C. In addition, this can also be produced by preparing the master batch in the manner described above and reheating followed by inflation molding or T-die extrusion. At this time, skin layers composed of olefin-based resin and the like may be co-extruded or films serving as skin layers may be laminated by thermocompression bonding and the like on both sides of the oxygen-absorbing film to obtain a multilayer oxygen-absorbing film.

In the case of producing the oxygen-absorbing film of the present invention by T-die extrusion as well, after having obtained a kneaded body comprised of each material from an extruder, the film can be extruded from the T-die extruder, and in this case as well, the oxygen-absorbing film is preferably formed after obtaining a master batch in advance. In addition, skin layers composed of olefin-based resin and the like may be co-extruded or films serving as skin layers may be laminated by thermocompression bonding and the like on both sides of the oxygen-absorbing film to obtain a multilayer oxygen-absorbing film.

Furthermore, in an oxygen-absorbing resin composition using pyrogallol and/or hydroxyquinol as a main reactant, when a conventionally used resin is used, although there are no problems in terms of forming into a film by pressing, when a film is attempted to be formed by T-die extrusion or inflation molding, it was determined that the extruded amount of resin is not stable, thereby preventing stable film formation.

The cause of this was determined to be that, although conventionally used gallic acid has a melting point of 250° thereby resulting in it not melting at the film forming temperature, since pyrogallol or hydroxyquinol has a melting point of about 130° C. that is lower than the film processing temperature, these components end up liquefying during film formation. Namely, although eduction of molten pyrogallol and/or hydroxyquinol can be prevented to a certain degree by adding an alkaline metal salt or alkaline earth metal salt as previously described, this actually is thought to act as a plasticizer at high temperatures since these components end up melting. This thought to be the cause of the film being unable to be stably formed by T-die extrusion or inflation molding.

Therefore, as a result of conducting extensive studies, the inventors of the present invention discovered that, in the case of using a main reactant in the form of pyrogallol, hydroxyquinol or a mixture thereof, it is important to not focus on the thermal properties of the resin binder alone, but rather focus on the melt mass-flow rate of the entire oxygen-absorbing resin composition, and forming the composition into a film by making this parameter to be within a specific range.

In the case of an oxygen-absorbing resin composition using pyrogallol and/or hydroxyquinol for the main reactant in particular, melt mass-flow rate in the case of measuring in compliance with JIS K7210 under conditions of a temperature of 190° C. and load of 21.18 N is preferably 0.5 g/10 min to 18.0 g/10 min. In the case of obtaining a melt mass-flow rate within this range for the oxygen-absorbing resin composition, a film can be easily formed by T-die extrusion or inflation molding.

A multilayer oxygen-absorbing film may have a structure in which, for example, a plurality of oxygen-absorbing resin compositions having different main reactant contents are respectively laminated into a single layer or film. In addition to containing different contents of the main reactant, a plurality of oxygen-absorbing resin compositions can also be used having different types and contents of the main reactant, thermoplastic resin, salt of an alkaline metal or alkaline earth metal or transition metal compound.

In addition, a multilayer oxygen-absorbing film may also have a three-layer structure in which a single layer or multilayer intermediate layer composed of the oxygen-absorbing resin composition is sandwiched between two skin layers. In this case, the multilayer oxygen-absorbing film has an oxygen-absorbing intermediate layer and two skin layers having that intermediate layer interposed there between. Among these, the intermediate layer serves as the core of the functional layer mainly responsible for absorption of oxygen. As a result of employing a structure in which two skin layers are laminated while sandwiching the intermediate layer on the inside and outside thereof (above and below in the direction of lamination), an oxygen-absorbing film can be obtained that has high mechanical strength and a smooth surface, thereby improving post-processing suitability. The skin layers can be composed of, for example, a resin such as polyolefin-based resin.

A single-layer or multilayer oxygen-absorbing film produced in this manner can also be used as a laminate for a packaging material by laminating with one or more types of combined base films (barrier films) selected from, for example, a polyester film, aluminum foil, silica/alumina-deposited polyester film, vinylidene chloride-coated film, vinyl chloride film and cast polypropylene film (CPP). In this case, however, a vinylidene fluoride-coated film and the like are preferably used for the barrier layers so as not to significantly react with metal detectors or microwave ovens. A known lamination method such as dry lamination or extrusion lamination can be used for the lamination method.

A packaging body can be fabricated by adhering films of this laminate for a packaging material comprising a single-layer or multilayer oxygen-absorbing film or by adhering with other films or laminates. Examples of forms of the packaging body include a pouch, PTP, blister pack or tube, and can be used in a desired form. The oxygen-absorbing film is preferably arranged on the inside of the aforementioned laminated package within the packaging body.

In the case of using the oxygen-absorbing film of the present invention or laminate comprising that film as an oxygen absorber, it is extremely useful for preventing oxidative degradation of various products such as foods, chemical agents, pharmaceuticals, cosmetics or electronic components since it does not significantly react with a metal detector or microwave oven.

The packaging body of the present invention is particularly useful as a result of being fabricated using the aforementioned oxygen-absorbing film. In this case, a single-layer or multilayer oxygen-absorbing film can be used as the innermost layer of the packaging body. For example, this type of packaging body can be fabricated by arranging a single-layer or multilayer oxygen-absorbing film on the inside of the aforementioned laminate for a packaging material and then mutually adhering by heat sealing and the like.

<Radiation-Treated or Heat-Treated Oxygen-Absorbing Resin Composition and Oxygen-Absorbing Film>

Moreover, the inventors of the present invention discovered that, by carrying out a specific treatment on the aforementioned oxygen-absorbing resin composition and oxygen-absorbing film, the oxygen absorption rates thereof can be significantly improved.

Examples of specific treatment include radiation treatment and heat treatment. Examples of radiation treatment include ultraviolet treatment, X-ray treatment, γ-ray treatment and electron beam treatment. More preferably, the specific treatment is γ-ray treatment or electron beam treatment. Although without being bounded by theory, the reason for oxygen absorption performance being improved by these treatments is thought to be that hydrogen of the hydroxyl groups of the benzenetriol dissociates more easily, thereby more effectively facilitating reaction with oxygen.

For example, since sterilization by irradiation does not significantly damage the materials of the irradiated target and does not allow harmful substances to remain accompanying chemical sterilization, it is used to sterilize medical equipment or sterile animal feed and the like. Examples of irradiation methods include incremental irradiation, in which a procedure consisting of transporting to an irradiation chamber with a belt conveyor, transporting outside the irradiation chamber after a fixed period of time and then again entering the irradiation chamber is repeated until a certain absorbed dose is achieved, and static irradiation, in which an irradiated target is placed in an irradiation chamber and irradiated. For example, sterilization of medical equipment with γ rays is carried out by irradiating at 25 kGy to 35 kGy.

Irradiation is carried out at 1 kGy to 200 kGy in order to improve oxygen absorption rate. If irradiation is carried out within this range, improvement of oxygen absorption rate is demonstrated and there is only a low risk of degradation of resin within the material. Radiation treatment may also be carried out in the same manner as the method described in Japanese Unexamined Patent Publication No. 2014-79916.

Examples of heat treatment include steam treatment and oven treatment.

Steam treatment in particular can be carried out in the same manner as so-called steam sterilization treatment. More specifically, the oxygen-absorbing resin composition and oxygen-absorbing film can be heated by sterilization treatment (autoclave sterilization) for eradicating pathogens and the like by using a pressure-resistant device or vessel that enables the inside thereof to be subjected to high pressure.

Since autoclave treatment using water (steam) is the simplest example of an autoclave in which a state of high temperature and high pressure is obtained if a sealed vessel containing water is heated, and the mechanism of this device is comparatively simple, it is used in various fields such as medicine or material science. Normally, treatment is carried out for 20 minutes using saturated steam at a pressure of 2 atm after raising the temperature of 121° C.

From the viewpoint of improving oxygen absorption rate, the temperature of heat treatment can be 40° C. or higher, 60° C. or higher or 80° C. or higher, while from the viewpoint of preventing melting or degradation of the binder resin used, heating can be carried out at 200° C. or lower, 180° C. or lower or 150° C. or lower (and particularly at a temperature lower than the melting point of the binder resin). The duration of heating can be made to be within 10 minutes to 24 hours depending on the heating temperature.

This treatment may be carried out directly on the aforementioned oxygen-absorbing resin composition or oxygen-absorbing film, may be carried out on a packaging body in which the aforementioned oxygen-absorbing resin composition and/or oxygen-absorbing film are enclosed, or may be carried out on a packaging body that uses the aforementioned laminate for a packaging material comprising the oxygen-absorbing film.

### Examples

### A. Test of Oxygen Absorbability of a Composition Containing Pyrogallol, Salt of Alkaline Metal or Alkaline Earth Metal and/or Transition Metal Compound

Various types of main reactants, salts of alkaline metals or alkaline earth metals and/or transition metal compounds were respectively incorporated in the amounts shown in Tables 1 and 2 and promptly mixed until their respective particles became fine and uniform. These were then dry-blended with binder resin, the resulting resin mixtures were melted and mixed at 170° C. using a Labo Plastomill (Toyo Seiki Seisaku-sho, Ltd.), and the mixtures were formed at 170° C. while drawing a vacuum through the vent hole using a T-die to fabricate the oxygen-absorbing films of Examples A1 to A24 and Comparative Examples A1 to A5 at a thickness of 60 μm to 70 μm.

<Evaluation of Formability>

Evaluation of production suitability during fabrication of the oxygen-absorbing films is also shown in Tables 1 and 2. Here, production suitability was evaluated from three viewpoints consisting of the presence or absence of bubbling, formed state and presence or absence of overflow of resin from the vent port.

Namely, in Table 1, cases in which there was bubbling during film formation were evaluated as “NG” or evaluated as “G” in the absence of bubbling. In addition, cases in which compatibility of the oxidized substance with the binder resin was poor resulting in eduction on the film surface, or cases in which film was formed having a striped pattern due to the resin not being uniformly extruded in the direction of width when extruded from the T-die, were evaluated as “NG” for the formed state, or evaluated as “G” in the absence of such problems. In addition, cases in which resin composition rose up from the vent hole when drawing a vacuum resulting in problems with stable formation of the film leading to overflow of resin from the vent port were evaluated as “NG” and cases in which such problems were absent were evaluated as “G”.

<Evaluation of Oxygen Absorption Performance>

In addition, the results of evaluating oxygen absorption performance of the resulting oxygen-absorbing film are shown in Tables 1 and 2. Oxygen absorption performance was evaluated in the same manner as the aforementioned Test A. Oxygen absorption performance was evaluated in the following manner. Namely, 100 cm² of the oxygen-absorbing film were placed in an aluminum laminated packaging pouch having a layer configuration consisting of PET, aluminum foil and polyethylene in that order, and the packaging pouch was then heat-sealed to seal in the shape of a tetrahedron so that the volume (amount of air) of the packaging pouch was 15 mL. After storing for 7 days at normal temperature, the oxygen concentration of the air inside the packaging pouch was measured followed by calculation of the amount of absorbed oxygen per 1 gram of the oxygen-absorbing film. The oxygen concentration inside the packaging pouch was measured by puncturing the pouch with the measuring needle of a diaphragm-type galvanic battery oxygen sensor in the form of the Pack Master Model RO-103 (Iijima Electronics Corp.)

TABLE 1

| | Oxygen Absorber | | | | Production Suitability | | | |
|---|---|---|---|---|---|---|---|---|
| | | Alkaline | | Binder | | | Overflow | |
| | | metal salt | Transition | Resin | | | of resin | Oxygen |
| | Main reactant | (parts by | metal compound | (parts by | | Formed | from vent | Absorbability |
| | (parts by weight) | weight) | (parts by weight) | weight) | Bubbling | State | port | (mL/g) |
| Example A1 | Pyrogallol 1.0 | K₂CO₃ 0.5 | Iron (III) | PE 6 | G | G | G | 3.60 |
| | | | stearate 0.05 | | | | | |
| Example A2 | Pyrogallol 1.0 | K₂CO₃ 0.5 | Iron (III) | PE 9 | G | G | G | 1.02 |
| | | | stearate 0.05 | | | | | |
| Example A3 | Pyrogallol 1.0 | K₂PO₄ 0.5 | Iron (III) | PE 9 | G | G | G | 0.16 |
| | | | stearate 0.05 | | | | | |
| Example A4 | Pyrogallol 1.0 | K₂PO₄ 1.0 | Iron (III) | PE 9 | G | G | G | 1.61 |
| | | | stearate 0.05 | | | | | |
| Example A5 | Pyrogallol 1.0 | K₂PO₄ 0.5 | Iron (III) | PE 9 | G | G | G | 0.03 |
| | | | stearate 0.05 | | | | | |
| Example A6 | Pyrogallol 1.0 | K₂CO₃ 0.01 | Iron (III) | PE 9 | G | NG | G | 0.38 |
| | | | stearate 0.05 | | | Eduction | | |
| Example A7 | Pyrogallol 1.0 | K₂CO₃ 0.05 | Iron (III) | PE 9 | G | G | G | 1.48 |
| | | | stearate 0.05 | | | | | |
| Example A8 | Pyrogallol 1.0 | K₂CO₃ 0.1 | Iron (III) | PE 9 | G | G | G | 1.29 |
| | | | stearate 0.05 | | | | | |
| Example A9 | Pyrogallol 1.0 | K₂CO₃ 0.3 | Iron (III) | PE 9 | G | G | G | 0.40 |
| | | | stearate 0.05 | | | | | |
| Example A10 | Pyrogallol 1.0 | K₂CO₃ 1.0 | Iron (III) | PE 9 | G | G | G | 1.41 |
| | | | stearate 0.05 | | | | | |
| Example A11 | Pyrogallol 1.0 | K₂CO₃ 1.5 | Iron (III) | PE 9 | G | G | G | 2.54 |
| | | | stearate 0.05 | | | | | |
| Example A12 | Pyrogallol 1.0 | K₂CO₃ 0.5 | Iron (III) | PP 9 | G | G | G | 0.29 |
| | | | stearate 0.05 | | | | | |
| Comp. Ex. A1 | Pyrogallol 1.0 | — | Iron (III) | PE 9 | NG | NG | G | — |
| | | | stearate 0.05 | | | Eduction | | |
| Comp. Ex. A2 | Gallic acid 1.0 | K₂CO₃ 0.5 | Iron (III) | PE 9 | NG | G | G | — |
| | | | stearate 0.05 | | | | | |
| Comp. Ex. A3 | Ascorbic acid 1.0 | K₂CO₃ 0.5 | Iron (III) | PE 9 | NG | NG | G | — |
| | | | stearate 0.05 | | | Striped | | |
| | | | | | | Pattern | | |
| Comp. Ex. A4 | Catechol 1.0 | K₂CO₃ 0.5 | Iron (III) | PE 9 | NG | G | G | — |
| | | | stearate 0.05 | | | | | |
| Comp. Ex. A5 | Gallic acid 1.0 | — | | PE 9 | G | G | G | 0.00 |

TABLE 2

| | Oxygen Absorber | | | | Production Suitability | | | |
|---|---|---|---|---|---|---|---|---|
| | | Alkaline | | Binder | | | Overflow | |
| | | metal salt | Transition | Resin | | | of resin | Oxygen |
| | Main reactant | (parts by | metal compound | (parts by | | Formed | from vent | Absorbability |
| | (parts by weight) | weight) | (parts by weight) | weight) | Foaming | State | port | (mL/g) |
| Example A13 | Pyrogallol 1.0 | K₂CO₃ 0.5 | — | PE 9 | G | G | G | 0.23 |
| Example A14 | Pyrogallol 1.0 | K₂CO₃ 1.0 | — | PE 9 | G | G | G | 0.42 |
| Example A15 | Pyrogallol 1.0 | K₂CO₃ 0.5 | Iron (III) | PE 9 | G | G | G | 0.64 |
| | | | stearate 0.0001 | | | | | |
| Example A16 | Pyrogallol 1.0 | K₂CO₃ 0.5 | Iron (III) | PE 9 | G | G | G | 1.85 |
| | | | stearate 0.001 | | | | | |
| Example A17 | Pyrogallol 1.0 | K₂CO₃ 0.5 | Iron (III) | PE 9 | G | G | G | 0.31 |
| | | | stearate 0.01 | | | | | |
| Example A18 | Pyrogallol 1.0 | K₂CO₃ 0.5 | Iron (III) | PE 9 | G | G | G | 0.52 |
| | | | stearate 0.10 | | | | | |
| Example A19 | Pyrogallol 1.0 | K₂CO₃ 0.5 | Iron (III) | PE 9 | G | G | G | 1.18 |
| | | | stearate 0.5 | | | | | |
| Example A20 | Pyrogallol 1.0 | K₂CO₃ 0.5 | Iron (III) | PE 9 | G | G | NG | 0.83 |
| | | | stearate 1.0 | | | | | |
| Example A21 | Pyrogallol 1.0 | K₂CO₃ 0.5 | Zinc (II) | PE 9 | G | G | G | 0.48 |
| | | | stearate 0.05 | | | | | |
| Example A22 | Pyrogallol 1.0 | K₂CO₃ 0.5 | Tris(2,4-penta- | PE 9 | G | G | G | 0.15 |
| | | | nedionato)iron 0.05 | | | | | |
| Example A23 | Pyrogallol 1.0 | K₂CO₃ 0.5 | Bis(2,4-penta- | PE 9 | G | G | G | 0.47 |
| | | | nedionato)copper 0.05 | | | | | |
| Example A24 | Phloroglucinol 1.0 | K₂CO₃ 0.5 | Iron (III) | PE 9 | G | G | G | 0.11 |
| | | | stearate 0.05 | | | | | |

Furthermore, in Tables 1 and 2, PE refers to low density polyethylene (Petrosene® 342, Tosoh Corp.), and PP refers to polypropylene (Novatec FG3DC, Japan Polypropylene Corp.).

With reference to Tables 1 and 2, in the oxygen-absorbing resin compositions using gallic acid, ascorbic acid or catechol as main reactant, which have a molecular structure similar to that of pyrogallol, bubbling occurred during film formation (Comparative Examples A2 to A4). In addition, although bubbling did not occur in the case of having formed the film by only kneading gallic acid into the resin without adding a salt of an alkaline metal or alkaline earth metal or a transition metal compound, oxygen absorbability was not demonstrated (Comparative Example A5). On the other hand, in the oxygen-absorbing resin compositions of the present invention that used pyrogallol for the main reactant, there was no bubbling during film formation and smooth oxygen-absorbing films were obtained (Examples A1 to A24). However, in the case of not containing a salt of an alkaline metal or alkaline earth metal despite using pyrogallol for the main reactant, bubbling and eduction of pyrogallol occurred during film formation (Comparative Example A1).

With reference to Tables 1 and 2, various substances were determined to be able to be used in various amounts for the salt of an alkaline metal or alkaline earth metal and the transition metal compound.

<Evaluation of Surface Roughness>

The arithmetic mean roughness Ra of Example A2 and Comparative Examples A2 and A3 was measured using a surface roughness tester (ET4000AK, Kosaka Laboratory, Ltd.) in compliance with ISO4287. A diamond stylus having a radius of curvature of the tip of 0.5 μm and tip angle of 60° was used. The results for arithmetic average roughness Ra are shown in Table 3.

TABLE 3

| | | Comparative | Comparative |
|---|---|---|---|
| | Example A2 | Example A2 | Example A3 |
| Arithmetic average | 0.38 | 5.74 | 6.23 |
| roughness Ra (μm) | | | |

As is clear from these results, a film formed using pyrogallol for the main reactant had low surface roughness and a smooth surface.

<Measurement of Melt Mass-Flow Rate (MFR)>

The MFR values of resin compositions used to form the oxygen-absorbing films of Examples A1 to A24 that had the lowest content of alkaline metal salt and was the softest (Example A6), had the highest content of alkaline metal salt and was the hardest (Example A11), and used PP for the binder resin (Example A12) were measured in compliance with JIS K7210 under conditions of a temperature of 190° C. and load of 21.18 N using a Melt Indexer (Technol Seven Co., Ltd.). The results are shown in Table 4.

TABLE 4

| | Example A6 | Example A11 | Example A12 |
|---|---|---|---|
| Main reactant content | 9.9 | 8.7 | 9.5 |
| MFR (g/10 min) | 11.02 | 7.55 | 12.40 |

On the basis of the above results, resin compositions of examples other than Examples A6, A11 and A12 were suggested to have MFR values between 0.5/10 min and 18.0 g/10 min.

<Oxygen-Absorbing Laminate and Oxygen-Absorbing Packaging Body Fabrication Examples>

The oxygen-absorbing film of Example A4 was dry-laminated onto the aluminum foil side of a base material (layer configuration: PET/aluminum foil) to obtain an oxygen-absorbing laminate (layer configuration: PET/aluminum foil/oxygen-absorbing film). In addition, two of these laminates were superimposed with the oxygen-absorbing film sides on the inside and heat-sealed on four sides to fabricate a four-side sealed pouch (oxygen-absorbing packaging body).

### B. Test of Film Formation Suitability in the Case of Changing Main Reactant Content and Type of Binder Resin

Oxygen absorbers comprising 100 parts by weight of pyrogallol, 50 parts by weight of potassium carbonate and 5 parts by weight of iron (III) stearate were incorporated and quickly mixed until their respective particles became fine and uniform. These were then dry-blended with binder resins in the amounts shown in Table 5 and of the types described in Table 6, and the resulting resin mixtures were kneaded using a Labo Plastomill mixer (Toyo Seiki Seisaku-sho, Ltd.) to fabricate oxygen-absorbing resin compositions for the films of Examples B1 to B22 and Comparative Examples B1 to B8. However, iron (III) stearate was not contained in the oxygen absorber in Example B5.

<Measurement of Melt Mass-Flow Rate (MFR)>

Each of the oxygen-absorbing resin compositions was measured for MFR in compliance with JIS K7210 under conditions of a temperature of 190° C. and load of 21.18 N using the Melt Indexer (Technol Seven Co., Ltd.). The results are shown in Table 5. In addition, the melt mass-flow rates (MFR) of the binder resins alone measured under the same conditions are shown in Table 6.

<Fabrication of Single-Layer Oxygen-Absorbing Films>

The resulting resin compositions were formed at a temperature of 170° C. using the T-die of a Labo Plastomill to a thickness of 60 μm to 70 μm. Formation ease was evaluated as “G” in the case of being able to mold the film without any problems, or evaluated as “NG” in the case the film was unable to be formed stably due to a lack of stability in the extruded amount, tearing, excessively high mechanical torque load or interruption. The results are shown in Table 5.

<Fabrication of Multilayer Oxygen-Absorbing Films>

Oxygen-absorbing films having a three-layer structure, in which the resulting resin compositions were used as intermediate layers and low density polyethylene layers (Petrosene® 180, Tosoh Corp.) were provided for the inner skin layer and outer skin layer, were formed at 170° C. using a multilayer inflation molding machine so that the thicknesses of the inner layer, oxygen-absorbing layer and outer layer were 10 μm, 30 μm and 10 μm, respectively for a total thickness of 50 μm to fabricate the films of Examples B2 to B22 and Comparative Examples B1 to B8. Formation ease was evaluated as “G” in the case of being able to formed the film without any problems, or evaluated as “NG” in the case the film was unable to be formed stably due to a lack of stability in the extruded amount, tearing, excessively high mechanical torque load or interruption. The results are shown in Table 5.

TABLE 5

| | Binder Resin | | Main | Oxygen | Resin | |
|---|---|---|---|---|---|---|
| | | MFR | Reactant | Absorber | Composition | Formation |
| | Type | (g/10 min) | Content (wt %) | Content (wt %) | MFR (g/10 min) | Stability |
| Example B1 | Resin B | 7.3 | 3.2 | 5.0 | 7.68 | G*¹ |
| Example B2 | Resin A | 11.3 | 2.3 | 3.5 | 14.32 | G |
| Example B3 | Resin A | 11.3 | 4.9 | 7.5 | 16.45 | G |
| Comp. Ex. B1 | Resin A | 11.3 | 10.7 | 16.6 | 29.53 | NG |
| Example B4 | Resin B | 7.3 | 3.2 | 5.0 | 7.68 | G |
| Example B5 | Resin B | 7.3 | 8.0 | 11.9*² | 9.60 | G |
| Example B6 | Resin B | 7.3 | 7.8 | 12.0 | 10.41 | G |
| Example B7 | Resin B | 7.3 | 13.7 | 21.2 | 14.31 | G |
| Comp. Ex. B2 | Resin B | 7.3 | 19.9 | 30.8 | 24.02 | NG |
| Comp. Ex. B3 | Resin B | 7.3 | 26.5 | 41.1 | 50.05 | NG |
| Example B8 | Resin C | 3.9 | 4.7 | 7.4 | 4.31 | G |
| Example B9 | Resin C | 3.9 | 13.9 | 21.6 | 6.69 | G |
| Example B10 | Resin C | 3.9 | 20.4 | 31.6 | 13.77 | G |
| Comp. Ex. B4 | Resin C | 3.9 | 27.2 | 42.1 | 19.39 | NG |
| Comp. Ex. B5 | Resin C | 3.9 | 31.6 | 49.1 | 28.36 | NG |
| Example B11 | Resin D | 1.9 | 2.2 | 3.4 | 2.14 | G |
| Example B12 | Resin D | 1.9 | 5.6 | 8.6 | 2.71 | G |
| Example B13 | Resin D | 1.9 | 18.1 | 28.1 | 6.04 | G |
| Example B14 | Resin D | 1.9 | 23.1 | 35.9 | 12.46 | G |
| Example B15 | Resin D | 1.9 | 28.8 | 44.6 | 17.42 | G |
| Example B16 | Resin E | 1.0 | 3.9 | 6.0 | 1.08 | G |
| Example B17 | Resin E | 1.0 | 8.7 | 13.5 | 1.31 | G |
| Example B18 | Resin E | 1.0 | 11.4 | 17.6 | 1.63 | G |
| Example B19 | Resin E | 1.0 | 19.1 | 29.6 | 3.90 | G |
| Example B20 | Resin E | 1.0 | 24.6 | 38.1 | 5.18 | G |
| Example B21 | Resin E | 1.0 | 31.0 | 48.1 | 4.86 | G |
| Comp. Ex. B6 | Resin F | 0.3 | 3.0 | 4.7 | 0.31 | NG |
| Comp. Ex. B7 | Resin F | 0.3 | 5.6 | 8.7 | 0.34 | NG |
| Comp. Ex. B8 | Resin F | 0.3 | 7.7 | 12.0 | 0.43 | NG |
| Example B22 | Resin F | 0.3 | 28.5 | 44.1 | 2.20 | G |

*¹Formation ease evaluated by T-die extrusion in Example B1
*²Transition metal compound not contained in Example B5

TABLE 6

| | Resin | | | | | |
|---|---|---|---|---|---|---|
| | Resin A | Resin B | Resin C | Resin D | Resin E | Resin F |
| Type | Petrosene | Petrosene | Petrosene | Petrosene | Petrosene | Petrosene |
| | 349 | 342 | 190 | 226 | 170 | 172 |
| MFR (g/10 min) | 11.3 | 7.3 | 3.9 | 1.9 | 1.0 | 0.3 |

All resins are available from Tosho Corp.

On the basis of the above results, formation ease was determined to be favorable if MFR values of the oxygen-absorbing resin compositions were within the range of 0.5 g/10 min to 18.0 g/10 min. In addition, even conventionally used hard resin having an MFR value of less than 7.3 g/10 min was determined to be useful as a binder resin in the case of using a comparatively large amount of main reactant that melted during film deposition. Since the containing of a large amount of main reactant makes it possible to enhance oxygen absorption performance, the combination of a main reactant that melts during film deposition with a hard resin is particularly useful.

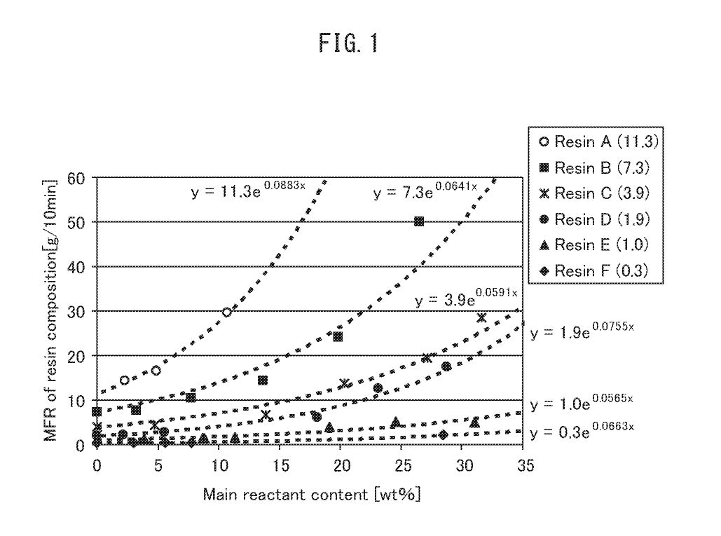

FIG. 1 indicates the relationship between main reactant content (x) and oxygen-absorbing resin composition MFR (y) obtained according to this test. In the case of using an oxygen absorber comprising 100 parts by weight of pyrogallol, 50 parts by weight of potassium carbonate and 5 parts by weight of iron (III) stearate, this relationship was determined to able to be roughly represented with the following equation using an exponential function.

y=M_{TR}×e^{0.0683x}

In this equation, M_{TR} represents the MFR of the binder resin and the exponent 0.0683 represents the average value of the exponent of an approximation formula derived from the results of measuring each binder resin.

Similarly, a person with ordinary skill in the art would be able to understand that, even in the case of using other types and different contents of main reactant, salt of an alkaline metal or alkaline earth metal and/or transition metal compound, the oxygen-absorbing resin composition satisfies the equation y=M_{TR}×e^{αx} (wherein, α represents a coefficient determined by the types and added amounts of main reaction and salt of an alkaline metal or alkaline earth metal and other optional conditions), and would be able to recognize the particularly useful range of the present invention.

<Evaluation of Oxygen Absorption Performance>

The oxygen absorption performance of the oxygen-absorbing film of Example B4 was evaluated in the manner indicated below. 100 cm² of the oxygen-absorbing film was placed in an aluminum-laminated packaging pouch having a layer configuration consisting of PET, aluminum foil and polyethylene in that order, and the pouch was then sealed by heat-sealing in the shape of a tetrahedron so that the volume (amount of air) of the packaging pouch was 15 ml. After storing for 30 days at normal temperature, the oxygen concentration in the air inside the packaging pouch was measured followed by calculating the amount of adsorbed oxygen per 1 cm² of the oxygen-absorbing film from the difference with the oxygen concentration in the atmosphere. The oxygen concentration inside the packaging pouch was measured by puncturing the pouch with the measuring needle of a diaphragm-type galvanic battery oxygen sensor in the form of the Pack Master Model RO-103 (Iijima Electronics Corp.).

As a result, the film of Example B4 absorbed oxygen at a rate of 0.0065 mL/cm², and was determined to be useful as an oxygen-absorbing film.

### C. Test of Oxygen Absorption Rate Based According to Presence or Absence of γ-Ray Treatment or Steam Treatment

<γ-Ray Treatment>

The oxygen-absorbing film of Example B4 was dry-laminated onto the aluminum foil surface of a base material (layer configuration: PET/aluminum foil) to obtain an oxygen-absorbing laminate (layer configuration: PET/aluminum foil/oxygen-absorbing film). In addition, two of these laminates were superimposed with the oxygen-absorbing film sides on the inside followed by inserting 5 mL of air in an environment at 23° C. and 50% RH and sealing on four sides to fabricate a four-side sealed pouch having outer dimensions of 100 mm×100 mm and a seal width of 10 mm (oxygen-absorbing packaging body).

Oxygen concentration inside two types of packaging bodies consisting of that subjected to γ-ray irradiation (25 kGy) and not subjected to γ-ray irradiation was measured with an oxygen sensor (Pack Master Model RO-103, Iijima Electronics Corp.). As a result, in contrast to oxygen concentration 4 days after irradiation being 1.25% for the packaging body irradiated with γ-rays, oxygen concentration was 20.3% in the packaging body not irradiated with γ-rays.

<Steam Treatment>

The oxygen-absorbing film of Example B4 was dry-laminated onto a base material (layer configuration: PET (12 μm)/aluminum foil (9 μm)) to obtain an oxygen-absorbing laminate (layer configuration: PET (12 μm)/aluminum foil (9 μm)/oxygen-absorbing film (50 μm)).

(1) This oxygen-absorbing laminate was cut out into the shape of a square measuring 130 mm on a side to fabricate a three-side sealed pouch (all pouch seal widths were 10 mm). Next, (2) oxygen-absorbing laminates were separately cut out into the shape of squares measuring 100 mm on a side. In addition (3) a PET film having a thickness of 100 μm was cut out into the shape of a square measuring 102 mm on a side and locations 2 mm from the edge were folded up on each side into the shape of a dish. Ten of the oxygen-absorbing laminates obtained in (2) were placed superimposed on the PET dish obtained in (3) with the oxygen-absorbing film sides facing downward and then placed in the three-side sealed pouch obtained in (1). The top of the pouch was then sealed (width: 10 mm) in an environment at 23° C. and 50% RH so that about 32 mL of air entered inside to obtain a four-side sealed pouch (oxygen-absorbing packaging body).

Oxygen concentration inside two types of packaging bodies consisting of that subjected to steam sterilization treatment for 20 minutes and 121° C. (steam sterilization device: RCS-60/10RSPXTG-FAM (82-2425), Hisaka Works, Ltd.) and that not subjected to steam sterilization treatment was measured with an oxygen sensor (Pack Master Model RO-103, Iijima Electronics Corp.). As a result, in contrast to oxygen concentration 10 minutes after steam sterilization treatment being 0.18% for the packaging body irradiated with γ-rays, oxygen concentration was 20.8% in the packaging body not subjected to sterilization steam treatment.

### INDUSTRIAL APPLICABILITY

The oxygen-absorbing resin composition of the present invention has a high level of oxygen absorption performance, can be formed into various films, and does not significantly react with metal detectors or microwave ovens, thereby making it extremely useful for preventing oxidative degradation of various products such as foods, chemical agents, pharmaceuticals, cosmetics or electronic components.

1. An oxygen-absorbing resin composition, comprising: a benzenetriol, a salt of an alkaline metal or alkaline earth metal and a binder resin; wherein, iron content is 1% by weight or less based on total weight.

2. The composition according to claim 1, wherein the content of resin binder is 89.7% or less based on total weight.

3. The composition according to claim 1, further comprising a transition metal compound.

4. The composition according to claim 3, comprising 0.0001 parts by weight to 0.8 parts by weight of the transition metal compound based on 1 part by weight of the benzenetriol.

5. The composition according to claim 1, comprising 0.005 parts by weight to 5.0 parts by weight of the salt of an alkaline metal or alkaline earth metal based on 1 part by weight of the benzenetriol.

6. The composition according to claim 1, wherein the benzenetriol is pyrogallol, hydroxyquinol or a mixture thereof, and melt mass-flow rate in the case of measuring in compliance with JIS K7210 under conditions of a temperature of 190° C. and load of 21.18 N is 0.5 g/10 min to 18.0 g/10 min.

7. The composition according to claim 6, wherein the content of the pyrogallol, hydroxyquinol or mixture thereof is 2.0% by weight to 31.0% by weight based on total weight.

8. The composition according to claim 1, wherein melt mass-flow rate in the case of measuring in compliance with JIS K7210 under conditions of a temperature of the binder resin of 190° C. and load of 21.18 N is 0.1 g/10 min to 18.0 g/10 min.

9. The composition according to claim 8, wherein the melt mass-flow rate is less than 7.3 g/10 min.

10. The composition according to claim 1, which is subjected to radiation treatment or heat treatment.

11. An oxygen-absorbing film obtained by forming the composition according to claim 1.

12. The film according to claim 11, having a thickness of 20 μm to 100 μm.

13. The film according to claim 11, wherein arithmetic average roughness Ra measured in compliance with ISO4287 is 3.0 μm or less.

14. The film according to claim 11, which is subjected to radiation treatment or heat treatment.

15. A packaging body fabricated using the film according to claim 11.

16. A method for producing an oxygen-absorbing film, comprising:
kneading a main reactant in the form of pyrogallol, hydroxyquinol or a mixture thereof and a salt of an alkaline metal or alkaline earth metal into a binder resin to obtain a resin composition having a melt mass-flow rate of 0.5 g/10 min to 18.0 g/10 min in the case of measuring in compliance with JIS K7210 under conditions of a temperature of the binder resin of 190° C. and load of 21.18 N, and
forming the resin composition into a film at a temperature of 130° C. to 250° C.

17. The method according to claim 16, further comprising carrying out a radiation treatment or heat treatment on the film.
